(19) United States
(12) Patent Application Publication
(10) Pub. No.: US 2004/0169969 A1
(43) Pub. Date: Sep. 2, 2004

(54) Safety device

(76) Inventor: Hideaki Takeda, Saitama (JP)

Correspondence Address: GREER, BURNS & CRAIN, 300 S WACKER DR, 25TH FLOOR, CHICAGO, IL, 60606, US

(21) Appl. No.: 10/480,407

(22) PCT Filed: Sep. 3, 2002
(86) PCT No.: PCT/JP02/08945

(30) Foreign Application Priority Data
Sep. 11, 2001 (JP) 2001-275698

(51) Int. Cl. H02H 3/00

(52) U.S. Cl. 361/42

(57) ABSTRACT

A safety device of the present invention copes with diverse abnormal conditions, and securely interrupts a driving current of an electric appliance by being combined with a normally used current interrupter. For example, a current interrupter that senses immersion or a ground fault is arranged in a power plug 50 at an end of a power cord 26, and a power switch 31 is connected to one power line 32-1, which is drawn from the power cord 26 to the inside of a hair-dryer 25, and a first sensor 34 and a second sensor 39 of a normal-time open-circuit type, which close a circuit when sensing an abnormal condition, are respectively arranged in a grip part 27 and an air blowing part 28 between the other power line 32-2 and the sensing line 33. When the sensor closes a circuit under abnormal conditions, a current flows into the sensing line 33, and the same state as that at the time of immersion or a ground fault emerges on the side of the current interrupter, so that the current of the hair dryer is immediately interrupted.

### TECHNICAL FIELD

The present invention relates to a safety device embedded in an electric product.

### BACKGROUND ART

Conventionally, various types of electric appliances are widely used at home or at worksites. However, it has been frequently seen and heard that an electric appliance causes a fire by being erroneously used or by being forgotten to be turned off power after use depending on the type of an electric appliance. As a familiar example, it has been frequently reported that a hair-dryer causes a fire.

Accordingly, in recent years, a safety element such as an electric current fuse, a temperature fuse, a thermostat, etc., which directly interrupts a power supply, has been provided within almost all electric appliances in order to ensure the safety under abnormal conditions. However, for an element that can perform only a single operation like a fuse, the element becomes unavailable if it performs a single interrupt operation. Therefore, the element must be replaced. Namely, the electric appliance must be repaired. However, since this is inconvenient, a thermostat that can repeatedly perform an operation is used in many cases especially for an electric appliance, etc., which needs to keep its usage temperature at a predetermined temperature or lower.

Furthermore, if a hair-dryer is taken as an example, which is an example mainly seen in the U.S., an accident where a hair-dryer is carelessly dropped in a bath, and an electric shock is given within the bath has frequently occurred. For this reason, it is mandatory to install a ground-fault interrupter in a plug so as to prevent such an electric shock accident.

Ground-fault interrupters include a type that interrupts a power supply by detecting a ground-fault current, and a type that interrupts a power supply by providing a sensing line and by detecting that an electric current flows into the sensing line. The type that detects a ground-fault current can cope with a case where a bath is insulated, whereas the type that is provided with a sensing line copes with a case where a bath is not insulated.

FIG. 1 shows a configuration example of such a conventional hair-dryer which interrupts a power supply by sensing immersion, and interrupts the power supply also by sensing an abnormal overheating. The hair-dryer 1 shown in this figure comprises a grip part 3 connected to a power cord 2, and an air-blowing part 4 that is arranged to protrude horizontally almost at a right angle from the top of the grip part 3, and formed integrally with the grip part 3.

A power switch 5 is arranged on the grip part 3, and this power switch 5 is connected in series with one power line 6-1 of two power lines 6 (6-1, 6-2), which are drawn from the power cord 2 to the inside of the grip part 3. A user can turn on/off a power supply by operating a switch knob 7 provided on this power switch 5.

From the power cord 2, an immersion sensing line 8, which is arranged within the power cord 2 along with the above described two power lines 6, is drawn, and wired to the inside of the air-blowing part 4 along with the power line 6-1 which passes through the power switch 5, and the power line 6-2 that is drawn from the power cord 2 unchanged.

In the air-blowing part 4, a heater unit 10 is arranged over a range from a central portion to an air outlet 9 at the left end portion. The power line 6-1 which passes through the power switch 5 is connected to an external terminal 11 of this heater unit 10, whereas the power line 6-2 is connected to the other external terminal 12. The external terminal 11 is linked to internal terminals 13 and 14 of the heater unit 10, whereas internal terminals 15 and 16 are linked to the external terminal 12.

In the largest possible area with the heater unit 10, a heat-producing line 17 of a predetermined length, which is configured by a nichrome line, etc., is arranged by being folded, and both of its end portions are respectively connected to the internal terminals 13 and 15. Almost in a central portion of the heat-producing line 17, a thermostat 18, which is in a closed-circuit state under normal condition, is connected in series.

Additionally, to the other internal terminals 14 and 16, an air blowing device composed of a motor 21 and a rotary vane 22 is connected. When this air blowing device is powered on by the power switch 5, the motor 21 rotates, and the rotary vane 22 rotates, so that outside air taken from an air intake 23 is transmitted to the air outlet 9. The heat-producing line 17 similarly produces heat by the power-on with the power switch 5, and heats the air while it is taken from the air intake 23 and transmitted to the air outlet 9. In this way, hot air is blasted from the air outlet 9.

If this hair-dryer 1 is erroneously dropped in a bath, etc., the immersion sensing line 8, which is drawn to proximity to the air outlet 9, senses water which internally intrudes, and the power supply is interrupted by an electric current interrupter arranged, for example, in a plug installed integrally at the end portion of the power cord 2. Or, if the inside of the air blowing part 4 abnormally overheats due to some reason such as dust clogging, etc., the thermostat 18 works to open a circuit, and interrupts a current which flows into the heat-producing line 17.

Thus, a safety device is installed to be able to cope with two abnormal environmental changes of immersion and overheating.

However, the safety device described above as a conventional technique has some problems.

First of all, electric appliances such as hair-dryers are still reported to cause fires, evethough a safety element like a thermostat that directly interrupts a power supply is internally provided as described above.

Next, with an increase in electric capacity in recent years, an electric appliance using high power has been known to be dangerous if only ON/OFF repetitive operations are merely performed like the above described thermostat. From the viewpoint of reliable safety, if an operation under abnormal conditions is performed once, a safety measure where restoration is not made to operations under normal conditions unless a reset is manually made, is desired.

However, a safety device of a conventional thermostat type is configured to interrupt a normal load current (main current which drives an electric appliance) by the thermostat itself. Therefore, a large contact point commensurate with a load current, and a spring member for maintaining contact reliability by securing a contact pressure at this contact point are essential from a structural viewpoint in order to apply a high electric current when power is applied under normal conditions.

Since the structure is complex as described above, a thermostat resetting method is difficult to execute with a manual operation, and a problem remains.

Furthermore, using, for example, a relay or an interrupter, which interrupts a power supply by applying power, is the most reliable way to interrupt a high electric current flowing into an electric appliance. However, a simple device that operates such a relay or an interrupter does not exist conventionally.

An object of the present invention is to provide a safety device that copes with abnormal conditions, and securely interrupts a driving current of an electric appliance by using a sensor having a simple and cheap configuration, and a commonly used electric current interrupter, in view of the above described circumstances.

### DISCLOSURE OF INVENTION

In a preferred embodiment of the present invention, a safety device is configured to comprise: a ground-fault sensing power interrupting device, which is arranged between a plug of a power cord for supplying power taken from a commercial power receptacle via the plug to an electric appliance and a power switch of the electric appliance, detecting a ground fault from the power cord and the electric appliance with an electric current sensor using a current transformer, and interrupting a power supply of the power cord based on this detection; a sensing line which is provided between a pair of power lines of the power cord, and one end of which is connected to one pole on a side of the pair of power lines not via the current transformer; and a sensor in an ordinary-temperature normal-time open-circuit state, which is provided in series with a resistor between the pole to which the sensing line of the electric appliance is connected on the side of the power lines and a charging part of a pole on an opposite side, wherein the sensor electrically generates the same effect as a ground fault for the ground-fault sensing power interrupter by closing a circuit when sensing an abnormal condition, and operates the interrupter, so that a power supply is interrupted.

In a preferred embodiment, a safety device is configured to comprise: an immersion sensing power interrupting device, which is arranged between a plug of a power cord for supplying power taken from a commercial power receptacle via the plug to an electric appliance and a power switch of the electric appliance, sensing that an electric current flows into a sensing line when a side of the electric appliance, to which the sensing line arranged separately from a pair of power lines of the power cord is connected, is immersed, and interrupting a power supply; and a sensor in an ordinary-temperature normal-time open-circuit state, which is provided in series with a resistor between the sensing line connected to the immersion sensing power interrupting device and a charging part of an arbitrary pole within the electric appliance, wherein the sensor electrically generates the same effect as immersion for the immersion sensing power interrupter by closing a circuit when sensing an abnormal condition, and operates the interrupter, so that a power supply is interrupted.

Additionally, the sensor is configured, for example, by a temperature sensor. In this case, the temperature sensor comprises: a pair of terminals arranged, for example, in parallel, a substrate part insulating and supporting the pair of terminals, and a bimetal arranged to face the pair of terminals within the substrate part. The bimetal is arranged in a way such that its warpage direction is set, at an ordinary temperature, to a direction where between said pair of terminals is opened, and contact is made with a metal cover provided on the substrate part, and configured to short-circuit between the pair of terminals at least at one end part by inverting the warpage direction at a preset temperature or higher.

Furthermore, the metal cover is configured, for example(?), to be a shape such that a central part of the bimetal is pressed to restrict an inversion space of the bimetal so as to short-circuit between the pair of terminals at both of end parts of the bimetal when the bimetal inverts the warpage direction at the preset temperature or higher.

The temperature sensor may be configured, for example(?), in a way such that a pair of electric wires, at least one of which is insulated by coated thermoplastic resin, are twisted, tensioned together, and installed between the power line(s?) and said sensing line, and the thermoplastic resin is softened and deformed when the sensor is overheated to a preset temperature or higher, so that the pair of electric wires contact and become electrically continuous.

Additionally, the sensor may be, for example, an electric current sensor, or, for example, a gas sensor. In this case, it is desirable that the gas sensor is a gas sensor sensitive to a combustive gas typified, for example, by oxygen, carbon dioxide, a liquefied petroleum gas, or natural gas.

In a further preferred embodiment, a safety device is configured in a way such that a pole, to which a sensing line is connected on a power supply side, is on a side of a neutral line, a pole, to which the sensing line (?) is connected on a side of an electric appliance, is on a side opposite to the side of the neutral line, and a resistor connected to the sensing line is installed on a side of an electric current interrupter.

As described above, according to the present invention, a sensor having a simple and cheap configuration in a normal-time open-circuit state, and an electric current interrupter of an abnormal condition sensing type like an existing electric current interrupting device, which senses abnormal conditions of immersion and a ground fault, and interrupts an electric current are combined and used, whereby a cheap safety device that easily and securely interrupts an electric current even under abnormal conditions other than immersion and a ground fault can be provided.

### BRIEF DESCRIPTION OF DRAWINGS

FIG. 1 shows a configuration example of a conventional hair-dryer that interrupts a power supply by sensing immersion, and interrupts the power supply also by sensing an abnormal overheating;

FIG. 2 schematically shows the configuration of a hair-dryer as an example of an electric appliance provided with a safety device in one preferred embodiment;

FIGS. 3A and 3B schematically show two configuration examples of a power interrupter embedded in a plug at an end of a power cord linked to a hair-dryer;

FIG. 4A shows an outside top view of a thermostat of a normal-time open-circuit type as an example of a temperature sensor embedded in a safety device, FIG. 4B shows its back view., and FIG. 4C shows its side view;

FIG. 5A is a plan view showing the internal configuration of a thermostat of a normal-time open-circuit type, FIG. 5B is its cross-sectional view in a short side direction, FIG. 5C is its cross-sectional view in a long side direction, and FIG. 5D is a schematic showing its operation state;

FIG. 6 is a plan view showing another configuration example of the thermostat as a temperature sensor; and

FIG. 7 is a schematic showing another configuration example of the temperature sensor of a normal-time open-circuit type.

### BEST MODE OF CARRYING OUT THE INVENTION

Preferred embodiments of the present invention are explained below with reference to the drawings.

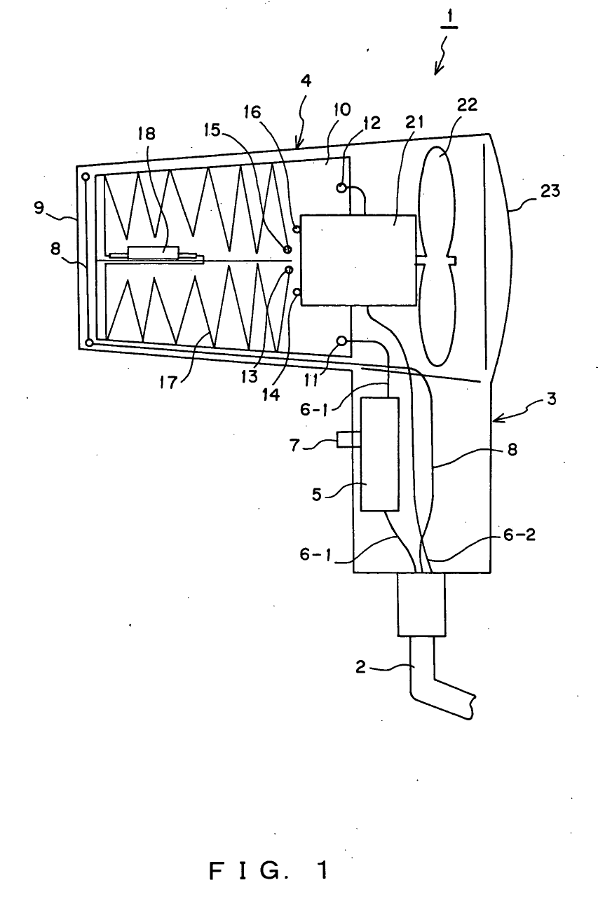

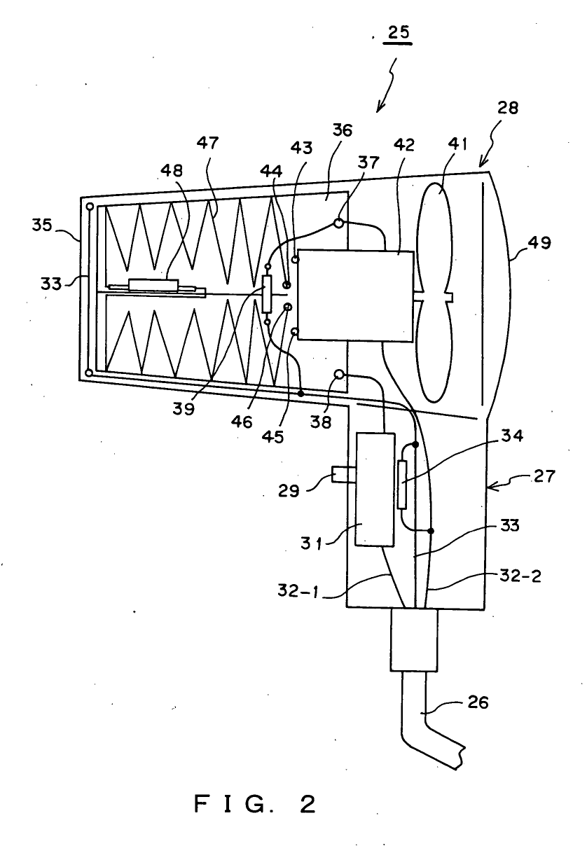

FIG. 2 schematically shows the configuration of a hair-dryer as an example of an electric appliance equipped with a safety device in one preferred embodiment. As shown in this figure, the hair-dryer 25 comprises: a grip part 27 that has a shape similar to that of the hair-dryer 1 shown in FIG. 1, and is connected to a power cord 26; and an air blowing part 28 that is provided to protrude horizontally almost at a right angle from the top of the grip part 27, and is formed integrally with the grip part 27.

Additionally, in the grip part 27, a power switch 31 having a switch knob 29 for operating the power-on/off of a power supply is arranged, and is connected in series with one power line 32-1 of two power lines 32 (32-1, 32-2), which are drawn internally from the power cord 26.

Furthermore, from the power cord 26, a sensing line 33 arranged within the power cord 26 is drawn along with the above described two power lines 32, and a first sensor 34, which configures a portion of the safety device of the present invention, is connected between the sensing line 33 and the power line 32-2 that is not connected to the power switch 31. This first sensor 34 is a sensor of a normal-time open-circuit type, which is configured to close a circuit when sensing an abnormal condition, and is arranged in Proximity the back portion of the power switch 31 in this embodiment.

Thus, the first sensor 34 is arranged within the grip part 27 in this embodiment. However, the first sensor 34 is not limited to this arrangement. This first sensor may be also arranged in an appropriate position within the power cord 26, for example, in Proximity to a connecting portion with the grip part 27, or in the neighborhood of a connecting portion with a power plug to be described later.

Additionally, this first sensor 34 is configured by a temperature sensor, a current sensor, a gas sensor, etc. In the case of a gas sensor, it is desirable to use a gas sensor sensitive to a combustive gas typified, for example, by oxygen, carbon dioxide, a liquefied petroleum gas, or natural gas.

Furthermore, in the other air blowing part 28, the power line 32-2, and the power line 32-1 that passes through the power switch 31 are respectively connected to external terminals 37 and 38 of a heater unit 36 arranged over a range from the center to an air outlet 35. Still further, a second sensor 39 is connected and arranged between the sensing line 33 that is drawn from the grip part 27 and extended and routed to the air outlet 35, and the other external terminal 37.

Also the second sensor 39 is configured by a temperature sensor, a current sensor, a gas sensor, etc. In the case of a gas sensor, it is desirable to use a gas sensor sensitive to a combustive gas typified, for example, by oxygen, carbon dioxide, a liquefied petroleum gas, or natural gas similar to that of the first sensor. This second sensor 39 is arranged in proximity to the back of a motor 42 which rotates and drives a rotary vane 41 of an air blowing device, namely, in a position that is shielded from air blown by the rotary vane 41 and is not blown by air.

The above described external terminals 37 and 38 are respectively linked to internal terminals 43 and 44, and 45 and 46 of the heater unit 36. The internal terminals 43 and 45 are connected to supply power to the motor 42, whereas the internal terminals 44 and 46 are connected to supply power to both end portions of a heat-producing line 47. The heat-producing line 47 is arranged to occupy the largest possible area within the heater unit 36 by being folded, and a thermostat 48 of a normal-time closed-circuit type is connected in series almost in a central portion.

When this hair-dryer 25 is powered on with an operation of the switch knob 29 via the power switch 31, the motor 42 rotates and drives the rotary vane 41, so that outside air taken from an air intake 49 is blasted from the air outlet 35 while being heated by the heat-producing line 47.

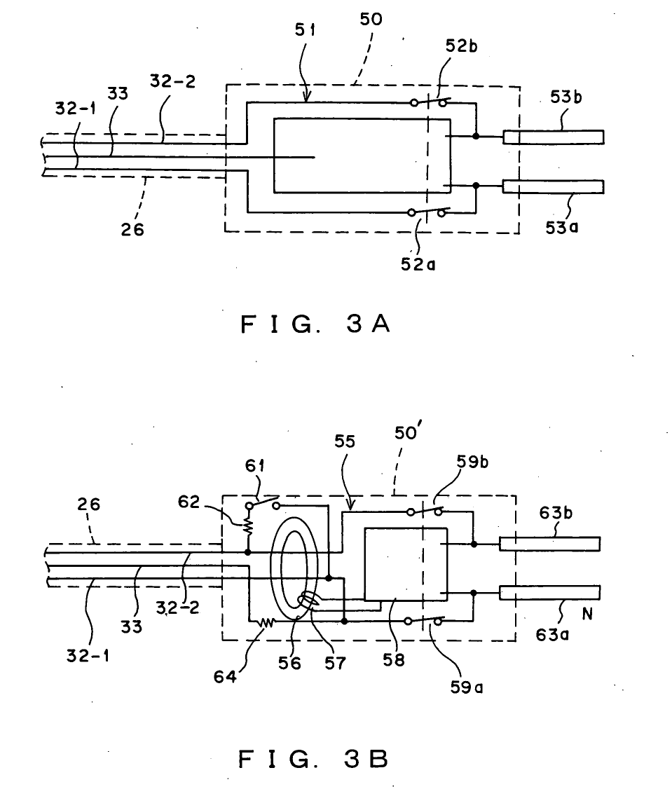

FIGS. 3A and 3B schematically show two configuration examples of a power interrupter embedded in a plug arranged at an end of the power cord 26 linked to the above described hair-dryer 25. FIG. 3A shows an example of an immersion sensing power interrupting device, whereas FIG. 3B shows an example of a ground-fault sensing power interrupting device.

For the power cord 26 shown in FIG. 3A, its outside contactable portion is coated with an insulative coating material, extending parts of the two power lines 32-1 and 32-2, which are arranged in parallel and shown in FIG. 2, and an extending part of the sensing line 33 arranged between these power lines 32-1 and 32-2 are arranged inside, and its end is connected to the immersion sensing power interrupting device 51 arranged within the plug 50.

A detecting circuit within the immersion sensing power interrupting device 51 comprises, for example, a switching element (such as a thyristor) using a semiconductor, a bridge circuit, and a solenoid having a minute configuration, which are not particularly shown, and all-time closed interlock switches with a latch 52a and 52b, which are shown in FIG. 3A. The end of the sensing line 33 is connected to a gate of the above described thyristor. As shown in FIG. 3A, the power lines 32-1 and 32-2 are respectively connected to one of the terminals of the all-time closed interlock switches with a latch 52a and 52b, whereas receptacle plug-in terminals 53a and 53b are respectively connected to the other terminals.

In this configuration, if the hair-dryer 25 shown in FIG. 2 is dropped within a bath, for example, with inadequate handling, the heat-producing line 47 and the sensing line 33 are first short-circuited by immersion from the air outlet 35 via the immersion water, and a current flows into the sensing line 33. When the current flows into the sensing line 33, the immersion sensing power interrupting device 51 turns on the thyristor to make the circuit electrically continuous, the solenoid is driven by the current which flows via the bridge circuit, and the all-time closed interlock switches 52a and 52b are opened by disengaging the latches, so that the currents of the power lines 32-1 and 32-2 are immediately interrupted at both poles. This current interrupt is not restored automatically unless the latches are manually reset.

Furthermore, in this entire configuration, the first sensor 34 or the second sensor 39 of a normal-time open-circuit type, which is shown in FIG. 2, closes a circuit when sensing an abnormal condition. In either case, the power line 32-2 and the sensing line 33, which are shown in FIG. 2, are short-circuited by the closing of the circuit. When the power line 32-2 and the sensing line 33 are short-circuited, a current flows into the sensing line 33, and the same situation as that at the time of the above described immersion electrically occurs for the immersion sensing power interrupting device 51. In this way, also in this case, the immersion ground-fault sensing power interrupting device 55 operates, and immediately interrupts a power supply.

Additionally, the ground-fault sensing power interrupting device 55 shown in FIG. 3B is configured by a sensor core 56, a sensor coil 57 wound around the sensor core 56, a switch driving part 58 operating based on the output of the sensor coil 57, all-time closed interlock switches 59a and 59b, which are opened by this switch driving part 58 under abnormal condition, and a test circuit composed of an all-time open switch 61 and a resistor 62.

The power lines 32-1 and 32-2, which are respectively connected to two receptacle plug-in terminals 63a and 63b of a plug 50′ via the all-time closed interlock switches 59a and 59b, are penetrated into the above described sensor core 56. The sensing line 33 passes through the outside of the sensor core 56, and is connected to the receptacle plug-in terminal 63b on the side of a neutral line (N) via the resistor 64, and one switch 59b of the all-time closed interlock switches.

In a normal state, currents having the same amount of current in reverse directions always flow into the power lines 32-1 and 32-2, which are penetrated into the sensor core 56. Therefore, induced magnetic forces are canceled, and a magnetic line does not occur within the sensor core 56. Accordingly, a current does not occur on the sensor coil 57. However, if the internal power line 32-1 or 32-2, or the sensing line 33 is broken by secular fatigue of the power cord 26, etc., and a portion of a twisted line bursts outside, the sensing line 33 arranged in between, and the power line 32-2 adjacent to the sensing line 33 contact and are short-circuited. As a result of this short-circuit, the voltage from the power line 32-2 is divided into the power line 32-1 on the ground-fault side and the sensing line 33, and a current difference occurs between the power lines 32-2 and 32-1. A magnetic line occurs within the sensor core 56 in response to the current by the current difference, and a current occurs on the sensor coil 57 in response to this magnetic line. This current is detected by the switch driving part 58. The switch driving part 58 comprises, for example, an amplification circuit, a latch solenoid, etc., which are not particularly shown, and a weak current from the sensor coil 57 is sensed by the amplification circuit. Namely, the output of the amplification circuit closes a power applied circuit within the switch driving part 58, and applies the power supply current to the latch solenoid. As a result, the latch solenoid operates, opens the all-time closed interlock switches 59a and 59b, and interrupts the power supply.

Furthermore, the test circuit composed of the all-time open switch 61 and the resistor 62 is a test circuit for verifying proper operations of the ground-fault sensing power interrupting device 55, such that the power supply is interrupted with an action similar to the above described one by artificially short-circuiting a portion of the power line 32-1 after the sensor core 56, and a portion of the power line 32-2 before the sensor core 56 by means of a connection of the receptacle plug-in terminals 63a and 63b to a power supply circuit for a test, and by means of closing of the all-time open switch 61 with an external manual operation or a jig after completion of assembly of the power cord 26 in a factory or prior to its shipment from the factory.

Also in this case, in this entire configuration, the first sensor 34 or the second sensor 39 of a normal-time open-circuit type, which is shown in FIG. 2, closes a circuit when sensing an abnormal condition. In either case, the closing of the circuit causes the power line 32-2 and the sensing line 33, which are shown in FIG. 2, to be short-circuited. When the power line 32-2 and the sensing line 33 are short-circuited, a current flows into the sensing line 33, and the same situation as that at the time of the above described immersion electrically occurs for the immersion sensing power interrupting device 51. As a result, also in this case, the immersion ground-fault sensing power interrupting device 55 operates, and immediately interrupts the power supply.

In the above examples, the immersion sensing power interrupting device 51 or the ground-fault sensing power interrupting device 55 is embedded in the plug of the end of the power cord. However, the device embedding is not limited to this implementation. The device may be embedded in a middle portion of the power cord as far as wiring in each portion is connected as shown in FIG. 3A or 3B. The point is that the device is arranged between a plug (more specifically, a receptacle plug-in terminal) of a power cord and a power supply switch of an electric appliance.

Furthermore, the above described first sensor 34 or second sensor 39 may be a sensor of a normal-time circuit type that senses an abnormal condition and closes a circuit as described above. Depending on the type and the use environment of an electric appliance in which a sensor is embedded, an appropriate sensor may be selected and embedded from among a temperature sensor, a current sensor, a gas sensor, etc.

As described above, the immersion sensing power interrupting device 51 or the ground-fault sensing power interrupting device 55, which is mandatory by a legal regulation in the U.S., etc. to be arranged, and is an essential configuration to an electric appliance, and a sensor according to a user environment are combined and installed, whereby not only abnormal conditions of immersion and a ground fault but also other abnormal conditions can be sensed, and a current can be quickly and securely interrupted by using the current interrupt function of the immersion sensing power interrupting device 51 or the ground-fault sensing power interrupting device 55.

Here, a temperature sensor is taken from among the above described sensors, and its configuration and operations are explained.

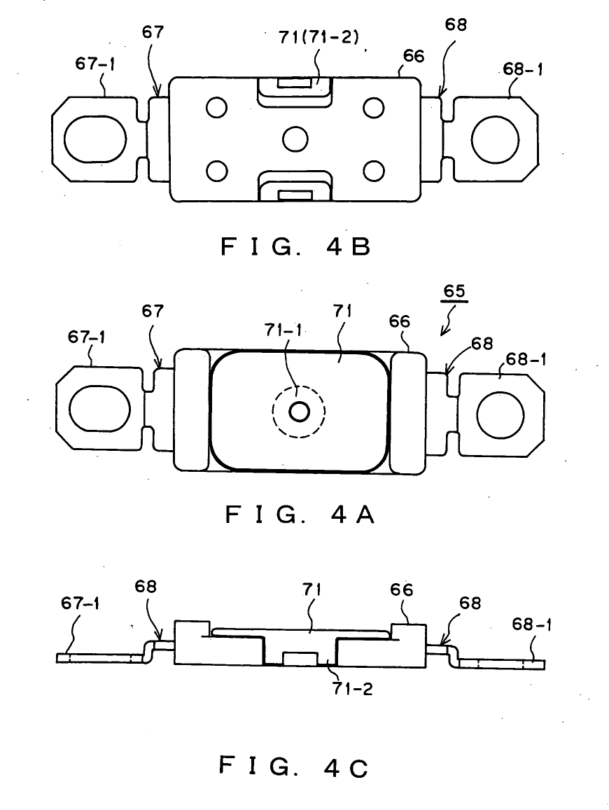

FIG. 4A is an outside top view of a sensor in an ordinary-temperature normal-time open-circuit state, which uses a bimetal, as an example of the temperature sensor, FIG. 4B is its back view, and FIG. 4C is its side view.

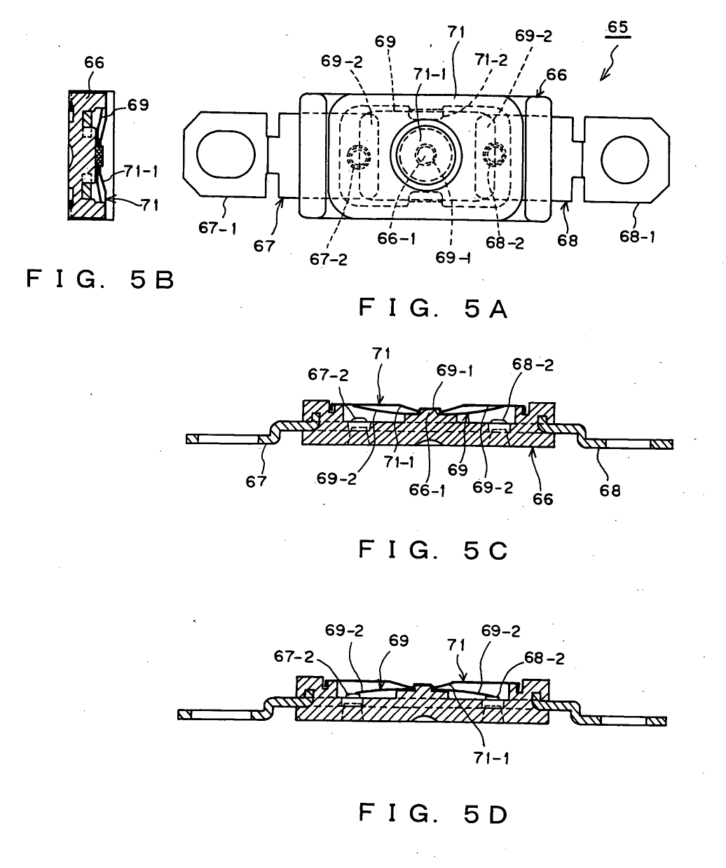

FIG. 5A is a plan view showing the internal configuration of the above described sensor in the ordinary-temperature normal-time open-circuit state, FIG. 5B is its cross-sectional view in the short side direction, FIG. 5C is its cross-sectional view in the long direction, and FIG. 5D shows its operation state.

As shown in FIGS. 4A to 4C, and 5A to 5D, this sensor in the ordinary-temperature normal-time open-circuit state (hereinafter referred to simply as a sensor in this embodiment) 65 comprises a substrate part 66 made of an insulative resin, etc., a pair of terminals 67 and 68, which are insulated and supported by the substrate part 66, a bimetal 69 arranged within the substrate part 66, and a metal cover 71 covering the bimetal 69.

The above described terminal 67 comprises an external terminal 67-1 arranged to protrude outside the substrate part 66, and an internal contact point 67-2 arranged within the substrate part 66. Also the terminal 68 comprises an external terminal 68-1 arranged to protrude outside the substrate part 66, and an internal contact point 68-2 arranged within the substrate part 66. The bimetal 69 is arranged within the substrate part 66 by aligning the front, the back, the left, and the right with an insertion of a central convex part 66-1 of the substrate part 66 into a hole 69-1 formed in the center. A central convex face 71-1 of the protection cover 71 abuts against the periphery of the aligned central portion of the bimetal 29, so that the up-and-down displacement range of the bimetal 69 at the time of its warpage is restricted.

The protection cover 71 is arranged to get under the bottom face of the substrate part 66 in a shape such that the tips of protrusion parts 71-2 in a central portion on both sides are bent inward. In this way, the protection cover 71 fixes its position by enfolding the substrate part 66 with the protrusion parts 71-2, and ensures the pressing (restriction force) of the central convex face 71-1.

The warpage direction of this bimetal 69 is preset, at a normal time (at an ordinary temperature), to a direction where contact is not made with the pair of terminals 67 and 68 (namely, the internal contact point 67-2 of the terminal 67 and the internal contact point 68-2 of the terminal 68. The same is applied hereinafter) as shown in (d) and (e) of this figure. At this time, end parts 69-2 and 69-2 of the bimetal 69 in the long side direction abut against the back face of the protection cover 71.

In the above described positional relationship between the bimetal 69 at an ordinary temperature and the protection cover 71, the protection cover 71 is provided in an appropriate position, whereby settings can be made to apply an adequate pressure to the bimetal 69 in a range that does not influence the warpage shape of the bimetal 69 and an inversion characteristic from this shape. As a result, the end parts 69-2 and 69-2 of the bimetal 69 in the long side direction, and the back face of the protection cover 71 contact each other with an adequate pressure.

It is desirable that a material of the protection cover 71 maybe a material having high heat conductivity, such as a metal, ceramic, etc. If the protection cover 71 is of a material having high heat conductivity, the heat-sensitive responsiveness of the bimetal 69 can be improved for a rise in an ambient temperature. This is because the bimetal 69 and the protection cover 71 contact with an adequate pressure at both of the end parts 69-2 and 69-2 of the bimetal 69 in the long side direction as described above, and the ambient temperature is well transferred to the bimetal 69 via the protection cover 71.

Additionally, when the bimetal 69 warps in the direction where contact is not made with the pair of terminals 67 and 68 as described above, and the sensor 65 is in an open state, heat externally transferred to the bimetal 69 comes only from both of the end parts 69-2 in the long side direction, which contact the protection cover 71, and from the central part which contacts the substrate part 66. A distribution of the heat externally transferred to the bimetal 69 is always symmetric with respect to the center, and a large mal-distribution of heat does not exist, so that a temperature sensing switch having stable heat responsiveness can be formed.

If the ambient temperature of the sensor 65 becomes a predetermined temperature or higher, the bimetal 69 inverts its warpage direction, and respectively contacts the pair of terminals 67 and 68 at least at one point as shown in FIG. 5D, thereby short-circuiting between the pair of terminals 67 and 68.

When the bimetal 69 inverts its warpage direction to respectively contact the pair of terminals 67 and 68 as described above, the protrusion part 71-1, which is formed in the downwardly convex state in the center of the protection cover 71, contacts, with pressure, the central portion of the bimetal 69, which becomes the upwardly convex state by this inversion, as shown in FIG. 5D, so that the pressing part which restricts the inversion displacement space of the bimetal 69 is formed.

As described above, the displacement space of the central portion, which is deformed to be the upwardly convex state, of the bimetal 69, is restricted, whereby stress, which is generated by inversion displacement and makes downward inversion with this central portion as a center, can be concentrated on both of the end parts 69-2 and 69-2 in the long side direction, which are the endmost parts. As a result, both of the end parts 69-2 and 69-2 in the long side direction contact the terminals 67 and 68 with a higher pressure, so that the contact between the terminals 67 and 68 is ensured.

A contact point of a conventional bimetal arranged, for example, within a thermostat, and a terminal contact point of an electric open circuit are generally of a normal-time closed-circuit type. In that case, a structure to ensure a contact pressure between the bimetal in a closed state and the terminal contact point via a contact reinforcing spring plate is adopted. Pressure at the contact point, which is set with the contact reinforcing spring plate, is normally on the order of 10 g.

The bimetal used for the sensor in this embodiment does not have a reinforcing material like a contact reinforcing spring plate for contact with a terminal contact point of an electric open circuit when the circuit is closed, and has an extremely simple structure of only a bimetal. However, the displacement of the center of the inverted bimetal is restricted by the central convex part 71-1 of the metal cover 71, whereby pressure which exceeds the above described 10 g can be instantaneously generated in a portion contacting the contact point at the time of its inversion.

Accordingly, if configuration of a switch using a bimetal is implemented as an all-time open switch like the sensor in this embodiment, and is applied to a system where an instantaneous low current for performing a power supply interrupt operation may be only applied when the switch is closed under abnormal condition, it is unnecessary to apply a high main electric current for operating an electric appliance under normal condition. Therefore, the above described configuration can be fully utilized as a component embedded in a power interrupting device under abnormal condition.

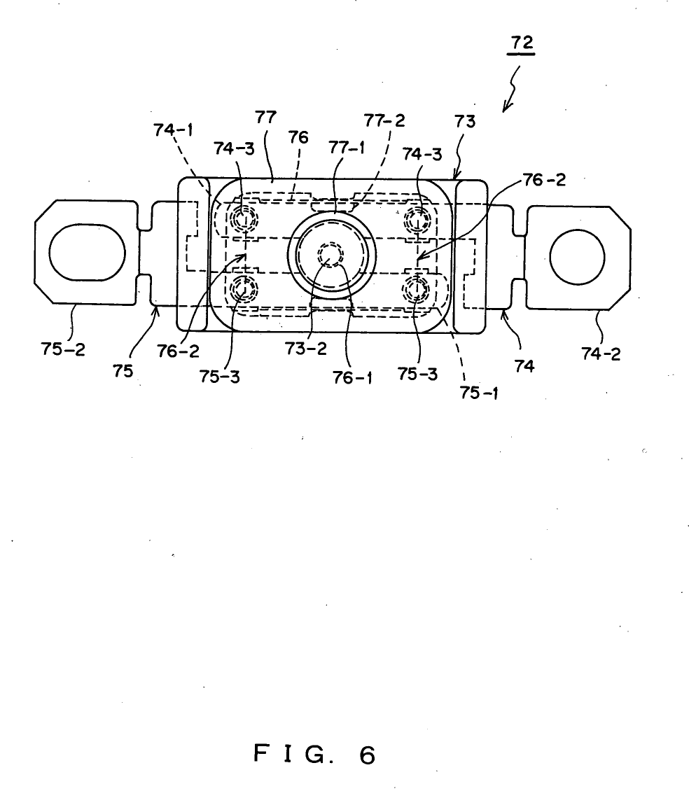

FIG. 6 is a plan view showing another configuration example of a sensor in an ordinary-temperature normal-time open-circuit state, which uses a bimetal, as a temperature sensor. Also the sensor 72 in the ordinary-temperature normal-time open-circuit state (hereinafter referred to simply as a sensor in this embodiment), which is shown in this figure, comprises a substrate part 73 made of an insulative resin, etc., a pair of terminals 74 and 75, which are insulated and supported by the substrate part 73, and a bimetal 76 arranged within the substrate part 73.

Also in this case, for the bimetal 76, a central convex part 73-2 of the substrate part 73 is inserted in a hole 76-1 formed in the center of the bimetal 76, so that the front, the back, the left, and the right are aligned, and an up-and-down displacement range of the aligned central part is restricted by a central convex face 77-1 of a protection cover 77. Additionally, protrusion parts 77-2 of the protection cover 77 in a lower center on both sides are arranged to get under the bottom of the substrate part 73 in the shape of being bent inside, and the protection cover 77 fixes its position by enfolding the substrate part 73 with the protrusion parts 77-2, so that the pressing (restriction force) of the above described central convex face 77-1 is ensured.

Additionally, the terminals 74 and 75 respectively comprise internal terminals 74-1 and 75-1, which are arranged in parallel within the substrate part 73, and external terminals 74-2 and 75-2, which are intended to make a connection to an external circuit. The internal terminals 74-1 and 75-1 respectively comprise a plurality of (two) contact points 74-3 and 74-3, and 75-3 and 75-3 in positions facing end parts 76-2 and 76-2 of the bimetal 76 in the long side direction. Note that, for example, bare lead wires may be used as the above described internal terminals 74-1 and 75-1, which are arranged in parallel.

Also the warpage direction of the bimetal 76 of this sensor 72 is preset to a direction where contact is not made with the pair of terminals 74 and 75 (namely, the contact points 74-3 and 74-3 of the terminal 74, and the contact points 75-3 and 75-3 of the terminal 75. The same is applied hereinafter) at an ordinary temperature in a similar manner as in the case of the sensor 65 shown in FIG. 5. Additionally, also the positional relationship between the bimetal 76 and the protection cover 77 at this time is similar to that in the case of FIG. 5.

In this sensor 72, if the bimetal 76 inverts the above described warpage direction when an ambient temperature becomes a predetermined temperature or higher, one end part 76-2 of the bimetal 76 in the long side direction contacts, with pressure, one contact points 74-3 and 75-3 of the parallel terminals 74-1 and 75-1, whereas the other end part 76-2 in the long side direction contacts, with pressure, the other contact points 74-3 and 75-3 of the parallel terminals 74-1 and 75-1 in a similar manner, so that the parallel terminals 74-1 and 75-1 are bridged and as a result, short-circuited.

In this way, this sensor 72 short-circuits between parallel terminals at two points at an end part in the long side direction, where the displacement of the rectangular bimetal 76 is the largest. As a result, short-circuits operate in parallel at two points, whereby contact reliability between the bimetal 76 and the terminals 74 and 75 is improved.

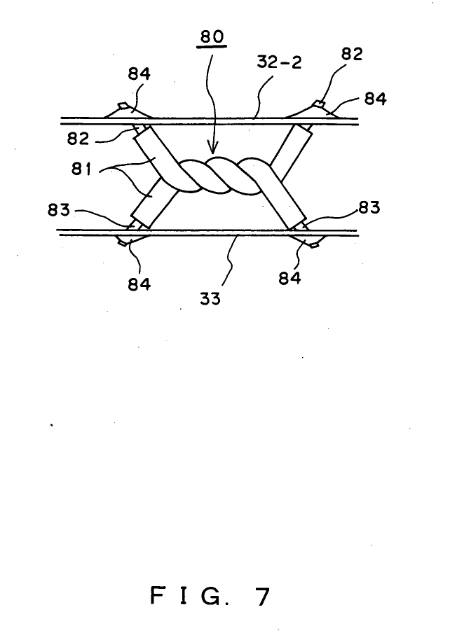

FIG. 7 shows a further configuration example of a temperature sensor of a normal-time open-circuit type. The temperature sensor 80 shown in this figure is configured by two twisted lines 82 and 83, which are respectively coated with a coating material 81 of a thermoplatic resin. The lines are twisted, tensioned, and connected between one power line 32-2 and the sensing line 33, which are shown in FIGS. 2 and 3, with solder 84. Tension between the power line 32-2 and the sensing line 33 may be assisted with a spring, etc. depending on need. Additionally, it is unnecessary to respectively apply the coating material 81 to the two twisted lines 82 and 83. The coating material 81 should be applied to at least one of the twisted lines 82 and 83.

For this temperature sensor 80, the coating material 81 of a thermoplastic resin is molten at a predetermined abnormal temperature, which makes the twisted lines 82 and 83 contact each other. Settings can be made to make the twisted lines 82 and 83 contact at a plurality of points depending on how to twist the lines. When the twisted lines 82 and 83 contact each other, short-circuit occurs between the power line 32-2 and the sensing line 33. This short-circuit causes the same state as immersion to emerge for the immersion sensing power interrupting device 51 if a current interrupting device is the immersion sensing power interrupting device 51, or causes the same state as a ground fault to emerge for the ground-fault sensing power interrupting device 55 if the current interrupting device is the ground-fault sensing power interrupting device 55, and a current is immediately interrupted.

As described above, an existing current interrupting device is utilized, and a sensor of a normal-time open-circuit type, which has the simplest possible and cheap configuration, is combined, so that a problem of ensuring safety, which cannot be conventionally coped with or is difficult to be coped with from a structural or an economic viewpoint, can be coped with, leading to improvements in safety.

Additionally, the surface of the bimetal may be plated to improve the contact state when the bimetal makes an inversion, and contacts a contact point under abnormal conditions. Moreover, the bimetal and a material resistant to oxidization may be bonded to prevent the secular degradation of the bimetal at an early stage.

Furthermore, with the configuration of the sensor using the bimetal, two characteristic structures such as a displacement range restriction and contact between two parallel points are adopted, whereby contact reliability, which is a difficult problem of a normal-time open-circuit type, is improved. As a result, a safety device whose stable sensing operations are guaranteed can be provided.

For a conventional dryer, if a safety element such as a thermostat or a temperature fuse is arranged in a position not blown by air as the second sensor of this embodiment, Joule heat equivalent of an electric current value cannot be cooled down, and a characteristic change becomes significant. Therefore, the safety element cannot be arranged in such a position. However, since such a position is apt to become a dead point, and a temperature rise under abnormal condition is high in many cases, the safety element of this embodiment, which can be arranged in such a position without any worries, is extremely effective from a safety viewpoint.

Additionally, the arrangement position of the sensor is not limited to those of the first and the second sensors shown in FIG. 2. Moreover, the number of sensors to be arranged is not limited to two. A plurality of types of sensors may be added and arranged without limits depending on a user safety requirement for an electric appliance.

Furthermore, for a conventionally used safety element of a normal-time power applied type (closed-circuit type), if the number of safety elements to be arranged is increased, they are to be connected in series on a power applied path. Therefore, characteristics and malfunctions of the respective safety elements must be considered beforehand to arrange the safety elements, and the number of elements to be arranged cannot be increased unlimitedly. However, the sensor as a safety element in this embodiment is a sensor of a normal-time open-circuit type, and is arranged between a power line and a sensing line. Therefore, a plurality of types of sensors can be added and arranged without limits (there are no limits theoretically) depending on a user safety requirement for an electric appliance.

For example, if a temperature sensor is arranged in proximity to a part within a power cord, which connects to a grip part of an electric appliance, or in Proximity to a part which connects to a power plug, an abnormal overheat caused by a short-circuit of a power line due to secular fatigue is sensed, and a power supply is interrupted, so that disasters such as a fire occurrence, etc. can be safely prevented.

Furthermore, also a current sensor, a gas sensor, etc. may be added and arranged in appropriate positions. By doing so, an almighty safety device is implemented. Even if a plurality of sensors are added and arranged in such a way, there are no fears that the added sensors exert a bad influence on the performance of an electric appliance.

### INDUSTRIAL APPLICABILITY

As described above, the safety device of the present invention is embedded in an electric product by being combined with a current interrupter of an abnormal condition sensing type like an existing current interrupting device which senses abnormal conditions, for example, of immersion and a ground fault, and interrupts an electric current. The present invention is available to all industries that produce an electric products and provides a cheap safety device which easily and securely interrupts an abnormal electric current due to immersion, ground fault, and other factors.

1. A safety device, comprising:
aground-fault sensing power interrupting device, which is arranged between a plug of a power cord for supplying power taken from a commercial power receptacle via the plug to an electric appliance and a power switch of the electric appliance, detecting a ground fault from the power cord and the electric appliance with an electric current sensor using a current transformer, and interrupting a power supply of the power cord based on this detection;
a sensing line which is provided between a pair of power lines of the power cord, and one end of which is connected to one pole on a side of the pair of power lines not via the current transformer; and
a sensor in an ordinary-temperature normal-time open-circuit state, which is provided in series with a resistor between the pole to which said sensing line of the electric appliance is connected on the side of the power lines and a charging part of a pole on an opposite side, wherein
said sensor electrically generates the same effect as a ground fault for said ground-fault sensing power interrupter by closing a circuit when sensing an abnormal condition, and triggers said interrupter, so that a power supply is interrupted.

2. A safety device, comprising:
an immersion sensing power interrupting device, which is arranged between a plug of a power cord for supplying power taken from a commercial power receptacle via the plug to an electric appliance and a power switch of the electric appliance, sensing that an electric current flows into a sensing line when a side of the electric appliance, to which the sensing line arranged separately from a pair of power lines of the power cord is connected, is immersed, and interrupting a power supply; and
a sensor in an ordinary-temperature normal-time open-circuit state, which is provided in series with a resistor between the sensing line connected to said immersion sensing power interrupting device and a charging part of an arbitrary pole within the electric appliance, wherein
said sensor electrically generates the same effect as immersion for said immersion sensing power interrupter by closing a circuit when sensing an abnormal condition, and operates said interrupter, so that a power supply is interrupted.

3. The safety device according to claim 1 or 2, wherein
said sensor is a temperature sensor.

4. The safety device according to claim 3, wherein:
the temperature sensor comprises
a pair of terminals arranged in parallel,
a substrate part insulating and supporting said pair of terminals, and
a bimetal arranged to face said pair of terminals within said substrate part; and
said bimetal is arranged in a way such that its warpage direction is set, at an ordinary temperature, to a direction where between said pair of terminals is opened, and contact is made with a metal cover provided on said substrate part, and said bimetal short-circuits between said pair of terminals at least at one end part by inverting the warpage direction at a preset temperature or higher.

5. The safety device according to claim 4, wherein
the metal cover is configured to be a shape such that a central part of said bimetal is pressed to restrict an inversion space of said bimetal so as to short-circuit between said pair of terminals at both of end parts of said bimetal, when said bimetal inverts the warpage direction at the preset temperature or higher.

6. The safety device according to claim 3, wherein
the temperature sensor is configured in a way such that a pair of electric wires, at least one of which is insulated by coated thermoplastic resin, are twisted, tensioned each other, and installed between the power line(s?) and said sensing line, and the thermoplastic resin is softened and deformed when the sensor is overheated to a preset temperature or higher, so that the pair of electric wires contact and become electrically continuous.

7. The safety device according to claim 1 or 2, wherein said sensor is an electric current sensor.

8. The safety device according to claim 1 or 2, wherein
said sensor is a gas sensor.

9. The safety device according to claim 8, wherein
the gas sensor is a gas sensor sensitive to a combustive gas typified by oxygen, carbon dioxide, a liquefied petroleum gas, or natural gas.

10. A safety device, wherein
a pole, to which a sensing line is connected on a power supply side, is on a side of a neutral line, a pole, to which the sensing line (?) is connected on a side of an electric appliance, is on a side opposite to the side of the neutral line, and a resistor connected to the sensing line is installed on a side of an electric current interrupter.
